(19) United States
(12) Patent Application Publication
(10) Pub. No.: US 2019/0265607 A1
(43) Pub. Date: Aug. 29, 2019

(54) IMAGE FORMING APPARATUS AND RECORDING MATERIAL DETERMINATION APPARATUS

(71) Applicant: CANON KABUSHIKI KAISHA, Tokyo (JP)

(72) Inventors: Mizuki Ishimoto, Numazu-shi (JP); Masafumi Monde, Kawasaki-shi (JP)

(21) Appl. No.: 16/275,951

(22) Filed: Feb. 14, 2019

(30) Foreign Application Priority Data
Feb. 26, 2018 (JP) 2018-032599

(51) Int. Cl. G03G 15/043; G03G 15/00

(52) U.S. Cl. CPC G03G 15/043; G03G 15/5062

(57) ABSTRACT

An image forming apparatus includes a transmission unit, a reception unit, an image forming unit, an irradiation unit, a light reception unit, and a controller. The transmission unit transmits ultrasonic waves. The reception unit receives the ultrasonic waves transmitted from the transmission unit through a recording material. The image forming unit forms an image on the recording material. The irradiation unit emits light. The light reception unit receives the light emitted from the irradiation unit and reflected by the recording material. The controller controls image forming conditions of the image forming unit based on an amplitude value of the ultrasonic waves received by the reception unit and a position in the light reception unit where the light reflected by the recording material is received.

### BACKGROUND OF THE INVENTION

### Field of the Invention

The present disclosure relates to a technique of determining a type of a recording material with high accuracy and controlling image forming conditions in accordance with a result of the determination.

### Description of the Related Art

In general, image forming apparatuses including copiers and printers may incorporate a sensor which determines a type of recording material. In such an apparatus, a type of recording material is automatically determined and transfer conditions (including a transfer voltage and a speed for conveying a recording material at a time of transfer, for example) and fixing conditions (including a fixing temperature and a speed for conveying a recording material at a time of fixing, for example) are controlled in accordance with a result of the determination.

Japanese Patent Laid-Open No. 2009-029622 discloses a recording material determination apparatus which determines a basis weight of a recording material by transmitting ultrasonic waves to the recording material and receiving the ultrasonic waves which have been attenuated through the recording material. An image forming apparatus including the recording material determination apparatus controls a transfer voltage, a fixing temperature, and a speed for conveying the recording material in accordance with a type of recording material which has been determined by the recording material determination apparatus. By this, a high-quality image may be formed on the recording material.

However, when the control disclosed in Japanese Patent Laid-Open No. 2009-029622 is performed, it is difficult to discriminate, with high accuracy, different types of recording material having similar basis weights, such as a thick recording material of low density and a thin recording material of high density. If a type of recording material is mistakenly determined, an image is formed under image forming conditions which are not suitable for the type of recording material, and therefore, image quality may be degraded. For example, a recording material of low density has a larger number of air spaces when compared with a recording material of high density, and therefore, heat is hard to be transmitted by the number of the air spaces. Accordingly, larger heat quantity is required to fix an image on the recording material of low density when compared with the recording material of high density. If the heat quantity is insufficient, an image is not fixed on the recording material and image quality is degraded.

Although the control disclosed in Japanese Patent Laid-Open No. 2009-029622 sufficiently attains image quality demanded at that time, improvement of accuracy of determination of a type of recording material is further demanded to attain image quality demanded in recent years.

### SUMMARY OF THE INVENTION

The present disclosure provides an image forming apparatus capable of determining a type of recording material with high accuracy so as to form a high-quality image.

According to an aspect of the present disclosure, an image forming apparatus includes a transmission unit configured to transmit ultrasonic waves, a reception unit configured to receive the ultrasonic waves transmitted from the transmission unit through a recording material, an image forming unit configured to form an image on the recording material, an irradiation unit configured to emit light, a light reception unit configured to receive the light emitted from the irradiation unit and reflected by the recording material, and a controller configured to control image forming conditions of the image forming unit based on an amplitude value of the ultrasonic waves received by the reception unit and a position in the light reception unit where the light reflected by the recording material is received.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of an image forming apparatus according to a first embodiment.

FIG. 2 is a block diagram illustrating a basis weight detection unit and a thickness detection unit according to the first embodiment.

FIG. 3 is a diagram illustrating a configuration of a basis weight sensor unit.

FIG. 4 is a diagram illustrating reception waveforms of the basis weight sensor unit.

FIG. 5 is a diagram illustrating a configuration of a thickness sensor unit.

FIG. 6 is a graph of the relationship between a detection value of the thickness detection unit and a thickness of a recording material.

FIGS. 7A and 7B are diagrams illustrating a recording material determination table using basis weight detection and thickness detection.

FIG. 8 is a flowchart of an operation sequence according to the first embodiment.

FIG. 9 is a diagram illustrating an example of a configuration of an image forming apparatus according to a second embodiment.

FIG. 10 is a block diagram illustrating a basis weight detection unit, a thickness detection unit, and a surface property detection unit according to the second embodiment.

FIG. 11 is a diagram illustrating a configuration of a surface property sensor unit.

FIG. 12 is a diagram illustrating an imaging range of the surface property sensor unit.

FIGS. 13A and 13B are diagrams illustrating a method for calculating a feature value of a surface property.

FIGS. 14A to 14C are diagrams illustrating a recording material determination table using surface property detection, basis weight detection, and thickness detection.

FIG. 15 is a flowchart of an operation sequence according to the second embodiment.

### DESCRIPTION OF THE EMBODIMENTS

### First Embodiment

In a first embodiment, an image forming apparatus including a recording material determination apparatus which determines a type of recording material using information on a basis weight of a recording material and information on a thickness of the recording material will be described.

### Schematic Configuration Diagram of Image Forming Apparatus

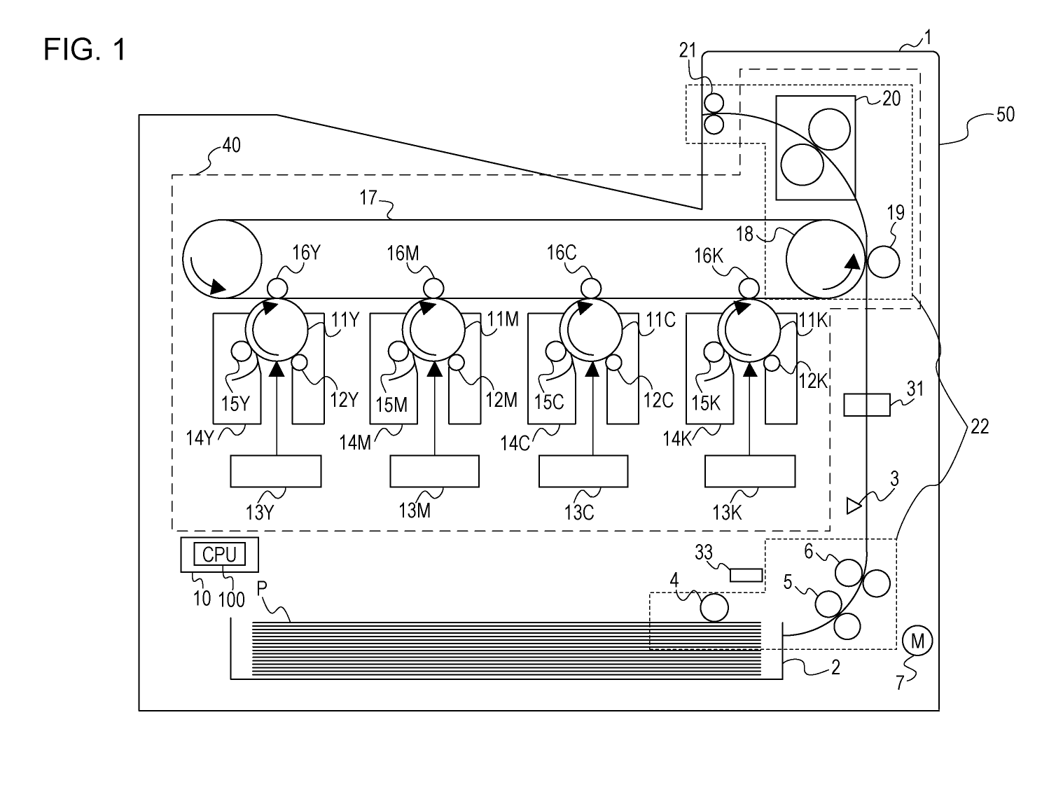

FIG. 1 is a diagram schematically illustrating a configuration of an image forming apparatus according to the first embodiment of the present disclosure. Note that a laser beam printer 1 (hereinafter referred to as a “printer 1”) employing an electrophotographic method is taken as an example of the image forming apparatus in this embodiment.

The printer 1 which is a tandem-type color laser beam printer outputs a color image by overlapping toners which are developers of four colors, that is, yellow (Y), magenta (M), cyan (C), and black (K) with one another.

A plurality of sheets P (recording materials) are stacked on a sheet feeding cassette 2 (a tray). A sheet feeding roller 4 feeds (supplies) each of the sheets P from the sheet feeding cassette 2. A conveyance roller pair 5 and a registration roller pair 6 which convey the sheet P which has fed by the sheet feeding roller 4 are disposed on a conveyance path (a conveyance guide) of the sheet P. A registration sensor 3 which detects a position of the sheet P is disposed in a position in the vicinity of the registration roller pair 6.

Photosensitive drums 11 (11Y, 11M, 11C, and 11K) bear toners of the respective colors. Charge rollers 12 (12Y, 12M, 12C, and 12K) of the respective colors uniformly charge the corresponding photosensitive drums 11 at a predetermined potential. Laser scanners 13 (13Y, 13M, 13C, and 13K) correspond to the four colors, respectively. Process cartridges 14 (14Y, 14M, 14C, and 14K) visualize electrostatic latent images formed on the photosensitive drums 11. Development rollers 15 (15Y, 15M, 15C, and 15K) supply toners of the process cartridges 14 to the photosensitive drums 11.

Primary transfer rollers 16 (16Y, 16M, 16C, and 16K) primarily transfer toner images formed on the photosensitive drums 11 to an intermediate transfer belt 17. The intermediate transfer belt 17 is driven by a driving roller 18. A transfer portion 19 is a secondary transfer roller which transfers a toner image formed on the intermediate transfer belt 17 onto the sheet P. A conveyance speed of the registration roller pair 6 for conveying the sheet P is controlled based on a timing when the registration sensor 3 described above detects the sheet P, and the sheet P is conveyed to the transfer portion 19 at an appropriate timing. A fixing portion 20 is a fuser which fuses and fixes the toner image which has been secondarily transferred to the sheet P while conveying the sheet P. The photosensitive drums 11 to the fixing portion 20 described above constitute an example of an image forming unit 40.

A discharge roller 21 discharges the sheet P which has been subjected to the fixing performed by the fixing portion 20. Furthermore, in this embodiment, the sheet feeding roller 4, the conveyance roller pair 5, the registration roller pair 6, the driving roller 18, the transfer portion 19, the fixing portion 20, the discharge roller 21, and driving sources (not illustrated) which drive the components described above constitute an example of a conveying unit 22.

The printer 1 includes a recording material determination apparatus which determines a type of the sheet P. The recording material determination apparatus of this embodiment includes a basis weight detection unit 31 which detects information on a basis weight of the sheet P and a thickness detection unit 33 which detects information on a thickness of the sheet P. The basis weight detection unit 31 is disposed on the conveyance guide and detects the sheet P which is supplied from the sheet feeding cassette 2. The thickness detection unit 33 is disposed in a position facing the sheet P stacked on the sheet feeding cassette 2 and detects the sheet P stacked on the sheet feeding cassette 2.

A controller 10 (a determination unit) includes an MPU (micro processing unit) (not illustrated) including a central processing unit (CPU) 100. The controller 10 determines image forming conditions for the sheet P based on characteristics of the sheet P detected by the basis weight detection unit 31 and the thickness detection unit 33. The controller 10 integrally controls operations of the printer 1, such as control of an image forming operation including control of the driving sources associated with conveyance of the sheet P.

### Basis Weight Detection Unit 31

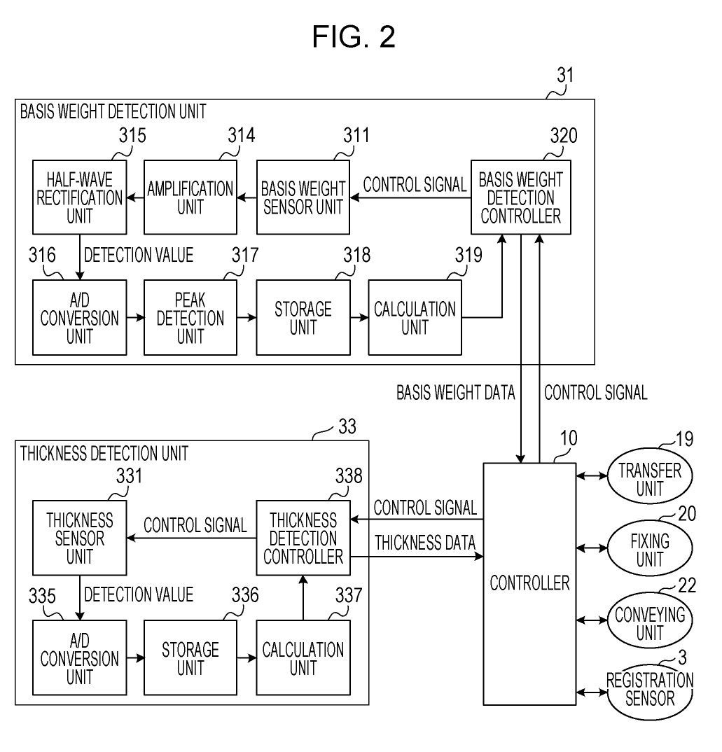

Operation of the basis weight detection unit 31 according to this embodiment will be briefly described. FIG. 2 is a block diagram schematically illustrating operation of the basis weight detection unit 31. The basis weight detection unit 31 includes a basis weight sensor unit 311, an amplification unit 314, a half-wave rectification unit 315, an A/D conversion unit 316, a peak detection unit 317, a storage unit 318, a calculation unit 319, and a basis weight detection controller 320.

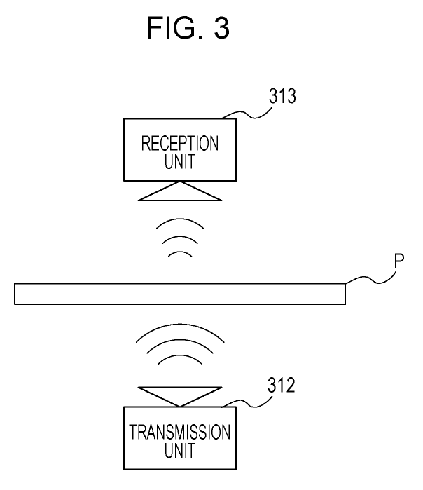

An example of a configuration of the basis weight sensor unit 311 is illustrated in FIG. 3. A term “basis weight” means mass of a recording material per unit area, and a unit thereof is g/m². Furthermore, the basis weight is represented by Expression (1) below.

Basis Weight [g/m²]=Thickness [m]×Density [g/m³] (1)

The basis weight sensor unit 311 includes a transmission unit 312 which transmits ultrasonic waves and a reception unit 313 which receives the ultrasonic waves. The transmission unit 312 emits ultrasonic waves to the sheet P and the reception unit 313 which faces the transmission unit 312 with the conveyance path interposed therebetween receives the ultrasonic waves which have been transmitted through the sheet P. Here, the emitted ultrasonic waves may not be orthogonal to a surface of the sheet P as long as the ultrasonic waves may be transmitted and received, and the transmission unit 312 and the reception unit 313 may be positioned so as to be inclined relative to the sheet P, for example.

The transmission unit 312 and the reception unit 313 have the same configuration, that is, each of the transmission unit 312 and the reception unit 313 includes a piezoelectric element (also referred to as a “piezo element”) serving as a mutual conversion element between a mechanical displacement and an electric signal and an electrode terminal. The transmission unit 312 is a general-purpose ultrasonic wave transmission sensor capable of transmitting ultrasonic waves of 40 kHz and is capable of transmitting ultrasonic waves in an arbitrary sound pressure for a predetermined period of time. The reception unit 313 is a general-purpose ultrasonic wave reception sensor capable of receiving ultrasonic waves of an arbitrary frequency transmitted from the transmission unit 312 and outputs a voltage corresponding to a sound pressure (an amplitude value) of the received ultrasonic waves. A guide shape for improving directional characteristics of ultrasonic waves may be formed at apertures of the transmission unit 312 and the reception unit 313 so that transmission sensitivity and reception sensitivity of received ultrasonic waves are enhanced.

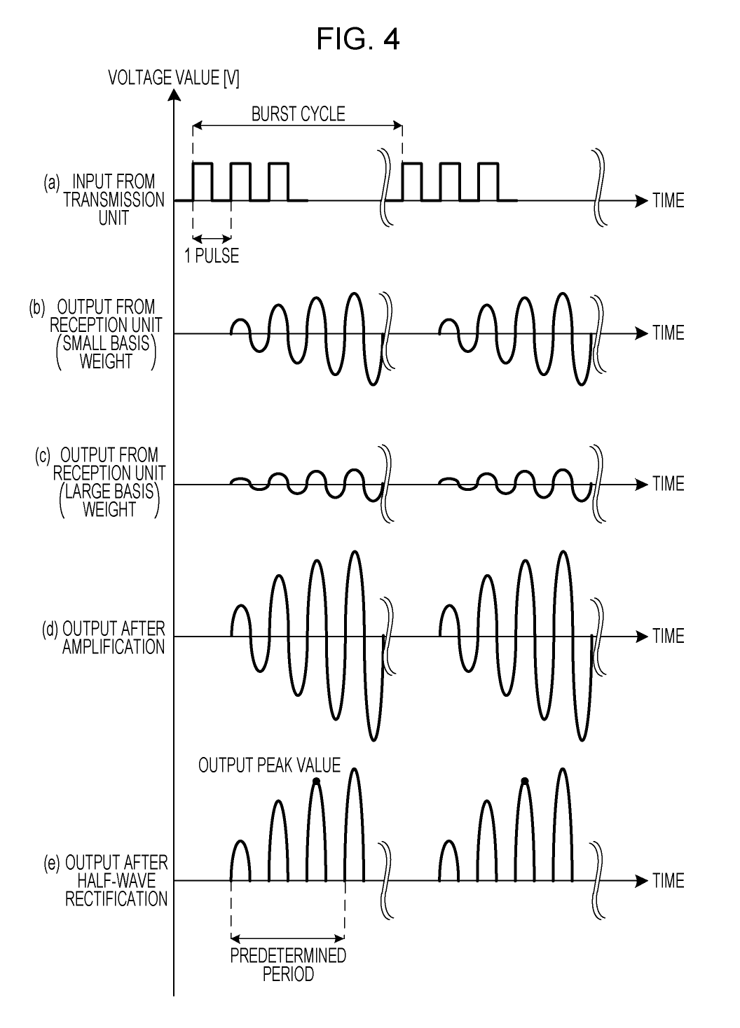

Here, outputs of the transmission unit 312 and the reception unit 313 will be described with reference to FIG. 4. An axis of abscissae denotes time and an axis of ordinates denotes an output voltage value V. In this embodiment, the transmission unit 312 successively outputs a plurality of pulse waves of 40 kHz (a). Then transmission of ultrasonic waves is stopped until ultrasonic waves between the transmission unit 312 and the reception unit 313 are attenuated, and thereafter, the pulse waves are similarly output again. This is performed so that influence of reflection waves from the sheet P and surrounding members is reduced. Such a burst wave is transmitted in a predetermined cycle and the transmission is repeatedly performed an arbitrary number of times so that ultrasonic waves are measured. Although a frequency of the ultrasonic waves transmitted from the transmission unit 312 is 40 kHz in this embodiment, an optimum frequency is preferably selected depending on detection accuracy.

Output of the reception unit 313 is increased or decreased depending on a basis weight of the sheet P. If a basis weight of the sheet P is small when the ultrasonic waves are received through the sheet P, the reception output is increased (b), and as the basis weight of the sheet P is increased, the reception output is decreased (c). The amplification unit 314 amplifies a received signal obtained by the reception unit 313 (d). In this embodiment, a gain of the reception signal varies between a case where the ultrasonic waves are received through the sheet P and a case where the ultrasonic waves are received without the sheet P. The half-wave rectification unit 315 performs half-wave rectification on the received signal which has been amplified by the amplification unit 314 (e). The A/D conversion unit 316 converts an obtained analog value into a digital value using an A/D converter. The peak detection unit 317 detects an output peak value in a predetermined period of time using the digital output value supplied from the A/D conversion unit 316. In this embodiment, the predetermined period of time is illustrated in (e) of FIG. 4, and a local maximum value of a third wave corresponds to the output peak value. However, an optimum period of time is not limited to this since the optimum period of time varies depending on a distance between the transmission unit 312 and the reception unit 313 or the like. The operation performed by the basis weight sensor unit 311 to the operation performed by the peak detection unit 317 are repeatedly performed as described above a number of times corresponding to the arbitrary number of times in which the measurement is performed.

The storage unit 318 stores a number of output peak values corresponding to the number of times the measurement is performed for the predetermined period of time detected by the peak detection unit 317. The calculation unit 319 calculates a value corresponding to a basis weight using measurement data. An average value of the measurement data which is obtained the arbitrary number of times and which is the output peak values obtained when the ultrasonic waves transmitted from the transmission unit 312 are directly received without the sheet P is referred to as an “output value without a sheet”. Furthermore, an average value of the measurement data which is obtained the arbitrary number of times and which is the output peak values obtained when the ultrasonic waves are received through the sheet P is referred to as an “output value with a sheet”. A transmission coefficient of the ultrasonic waves is obtained using the output value without a sheet and the output value with a sheet. The transmission coefficient is obtained by a rate of the output value with a sheet to the output value without a sheet and corresponds to a basis weight. The transmission coefficient is calculated in accordance with Expression (2) below.

Transmission Coefficient=Output Value with Sheet/Output Value without Sheet (2)

In this embodiment, the measurement is performed a plurality of times in different positions in a plane of the sheet P and detection values are averaged so that variation of the detection caused by non-uniformity of the basis weight in the plane of the sheet P is reduced. The number of times measurement is performed is preferably set as an optimum number of times in accordance with restrictions including a conveyance speed for conveying the sheet P and positional configurations of the units.

The basis weight detection controller 320 controls operation of the basis weight detection unit 31. The basis weight detection controller 320 controls a start timing and an end timing of a basis weight detection operation, a sound pressure of ultrasonic waves of the transmission unit 312, the number of pluses, a burst cycle, and the number of times the measurement is performed. Furthermore, the basis weight detection controller 320 transmits the obtained transmission coefficient to the controller 10.

The controller 10 calculates a basis weight using the transmission coefficient with reference to a table indicating the correlation between the transmission coefficient and the basis weight which is prepared in advance and controls the operations of the transfer portion 19, the fixing portion 20, and the conveying unit 22.

### Thickness Detection Unit 33

Operation of the thickness detection unit 33 according to this embodiment will be briefly described. FIG. 2 is also a block diagram schematically illustrating operation of the basis weight detection unit 33. The thickness detection unit 33 includes a thickness sensor unit 331, an A/D conversion unit 335, a storage unit 336, a calculation unit 337, and a thickness detection controller 338.

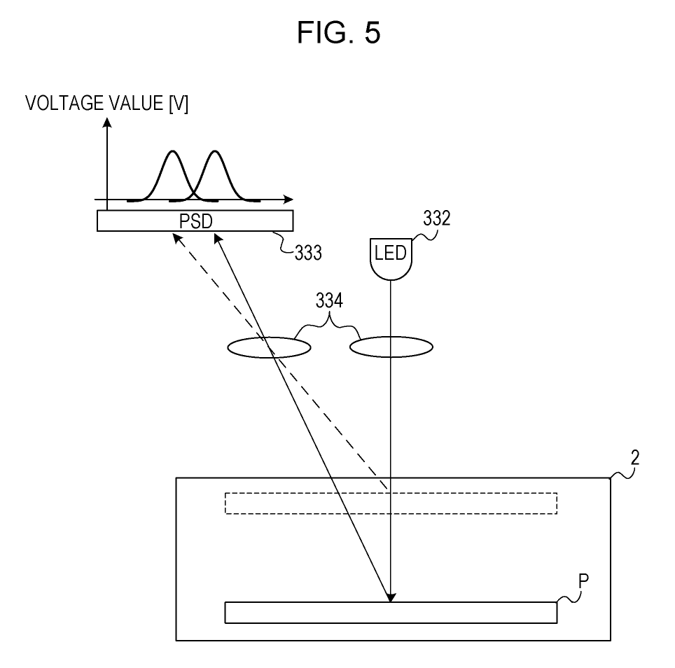

An example of a configuration of the thickness sensor unit 331 is illustrated in FIG. 5. The thickness sensor unit 331 includes an irradiation unit 332, a light reception unit 333, and condensing lenses 334. The irradiation unit 332 is a near infrared light emitting diode (LED) having a peak wavelength of 850 nm, and the light reception unit 333 is a position sensing device (PSD). A wavelength of light emitted from the irradiation unit 332 is at least receivable by the light reception unit 333. Furthermore, any light receiving element may be employed as long as the light receiving element is capable of detecting a displacement amount of a measurement target, and a complementary metal-oxide semiconductor (CMOS) sensor or a charge coupled device (CCD) sensor may be used instead for the detection, for example.

The thickness detection unit 33 collects light emitted from the LED using one of the condensing lenses 334 and irradiates the sheet P set in the sheet feeding cassette 2 with the light. Then the light reflected by the sheet P is collected by the other of the condensing lenses 334 and the collected light is received in an arbitrary range on a surface of the PSD. The condensing lenses 334 may not be required. That is, if an LED having high directionality is used, the condensing lenses 334 may not be disposed. Furthermore, guide shapes, such as apertures, may be formed instead of the condensing lenses 334 so that an irradiation range of light emitted from the irradiation unit 332 or a light reception range of the light reception unit 333 may be restricted. A center position of distribution of an amount of light emitted on a light reception plane of the PSD is displaced depending on a distance from a light reflection plane of the sheet P, and therefore, a distance to the sheet P may be calculated using a triangulation method.

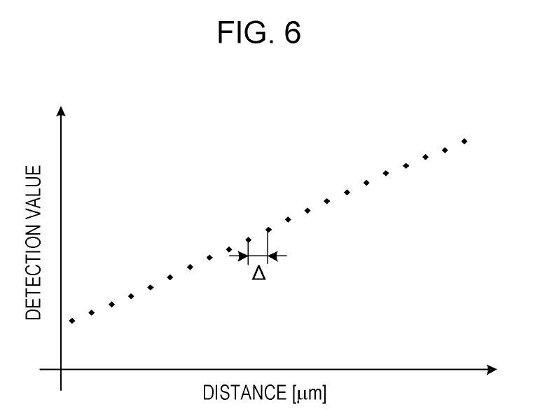

The A/D conversion unit 335 converts an analog value obtained from the light reception unit 333 into a digital value to be output. The storage unit 336 stores the digital output value supplied from the A/D conversion unit 335. The calculation unit 337 calculates a thickness of the sheet P using the obtained digital output value. The relationship between the detection value and the sheet P is illustrated in FIG. 6. An axis of abscissae denotes a distance from the surface of the sheet P to the light reception plane of the light reception unit 333, and an axis of ordinates denotes a detection value. Furthermore, in the plot, a detection value is measured every time the sheet P has passed. Specifically, first, the thickness detection unit 33 obtains a distance from the surface of the sheet P to the light reception plane of the light reception unit 333. When a predetermined period of time has elapsed, the distance is detected again after the single sheet P on an uppermost portion on the sheet feeding cassette 2 is fed. A difference between the distances is obtained so that a thickness of the sheet P is obtained. In FIG. 6, “Δ nm” denotes a thickness of a single sheet P.

The thickness detection controller 338 controls the operation of the thickness detection unit 33. The thickness detection controller 338 controls a start timing and an end timing of the thickness detection operation and driving of the irradiation unit 332 and the light reception unit 333. Furthermore, the thickness detection controller 338 transmits data on an obtained thickness of the sheet P to the controller 10.

The controller 10 controls operations of the transfer portion 19, the fixing portion 20, and the conveying unit 22 in accordance with a result of the detection of the thickness of the sheet P.

Note that, although the thickness of the sheet P is detected using an optical displacement sensor using triangle measurement as described above in this embodiment, any sensor may be employed as long as the thickness of the sheet P is detected and a laser displacement sensor or an ultrasonic displacement sensor may be used for the detection.

### Type of Sheet P and Image Forming Conditions

A type of sheet P and image forming conditions will be described. Different brands of sheets P have different characteristics including a basis weight, a thickness, density, and a surface property. Therefore, different brands have different characteristics even in a brand group generally classified as plain paper. In a case where sheets P are classified in different brand groups, a difference between characteristics of the sheets P is more significant. For example, sheets in a brand group referred to as bond paper have rougher surfaces and lower density and are thicker when compared with plain paper. Furthermore, sheets in a band group referred to as gloss paper have smoother surfaces and higher density and are thinner when compared with plain paper. In general, such characteristics of the sheets P considerably affect the image forming conditions of the printer 1. The image forming conditions include a speed for conveying the sheets P, a transfer condition in the transfer portion 19 (a transfer voltage to be applied to the transfer portion 19), and a fixing condition in the fixing portion 20 (a fixing temperature at a time when the fixing portion 20 fixes an image on the sheet P). A type of sheet P is required to be determined so that optimum image forming conditions are set in accordance with characteristics of the sheet P.

Furthermore, the image forming conditions may not be determined by a single characteristic. For example, even in a case of sheets having the same basis weight, different optimum image transfer conditions and different fixing temperatures are set depending on a type of sheet P. In a case where the sheet P is bond paper which has a rough surface and which is thick, a toner tends to be more difficult to be transferred on the sheet P when compared with plain paper and gloss paper which have basis weights similar to the bond paper and which are smooth, and therefore, a higher voltage value is required to be set at a time of the transfer. Furthermore, at a time when a toner is to be fixed on the sheet P, a higher fixing temperature is required to be set in the case of the bond paper since the toner is more difficult to be fixed on the sheet P which is the bond paper when compared with the plain paper and the gloss paper which have a smooth surface. In this way, different optimum image forming conditions are set when brands of the sheets P are different even though the basis weights of the sheets P are similar. Specifically, appropriate image forming conditions are required to be set taking various characteristics of the sheet P into consideration so that stability of image quality is improved.

### Variation of Detection Value

Variation of a detection value of a basis weight will be described. In general, even if the sheets P are the same brand, detection values of basis weights may be different depending on the sheets P. This occurs due to detection variation and the like caused by a difference of production lots of the sheets P or a sensor which detects a basis weight. Furthermore, the single sheet P has non-uniformity of the basis weight in the plane of the sheet P, and therefore, a detection value varies depending on a measurement position on the sheet P. Although the variation of a detection value may be reduced by averaging detection values obtained in a large detection area, a detectable area is restricted by a size of the sheet P or a configuration of the detection device, and therefore, it is difficult to reduce the detection variation. Therefore, a determination is made provided that a possible detection value has a range taking the variation of the detection value into consideration in practice. In this embodiment, a basis weight range is set taking the variation of a detection value of a basis weight into consideration as described below, and a basis weight of the sheet P is determined as a result of a determination as to whether a detection value is within the basis weight range. Similarly, a detection value of a thickness also varies due to the similar reason.

### Principle of Paper Type Detection

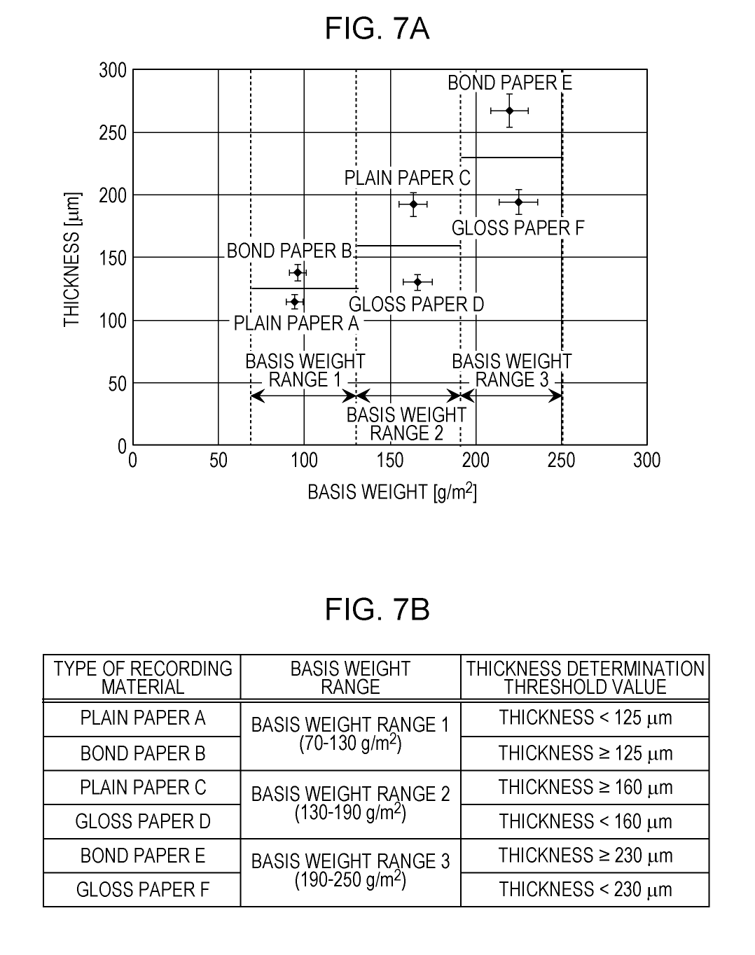

Principle of the recording material determination using the basis weight detection unit 31 and the thickness detection unit 33 will be described. FIG. 7A is an example of results of the basis weight detection and the thickness detection in a case of six different types of sheet P (plain paper A, bond paper B, plain paper C, gloss paper D, bond paper E, and gloss paper F). An axis of abscissae denotes a basis weight [g/m²] of the sheet P obtained as a result of the detection performed by the basis weight detection unit 31 and an axis of ordinates denotes a thickness [um] of the sheet P obtained as a result of the detection performed by the thickness detection unit 33. The plain paper A and the bond paper B have substantially the same basis weight of approximately 95 g/m², the plain paper C and the gloss paper D have substantially the same basis weight of approximately 165 g/m², and the bond paper E and the gloss paper F have substantially the same basis weight of approximately 220 g/m². Specifically, one of the two sheets P is relatively thick and has relatively low density, and the other is relatively thin and has relatively high density. These are examples of different types of sheet P having substantially the same basis weight.

A method for discriminating different types of sheet P having substantially the same basis weight will be described. As indicated by dotted lines in FIG. 7A, basis weight ranges incorporating the sheets P of substantially the same basis weights are set. It is assumed here that detection values of the basis weights and detection values of thicknesses of the individual types of sheet P vary by ±5% relative to the detection values. Variation ranges of the detection values are indicated by error bars. Furthermore, the basis weight ranges are set to incorporate the error bars.

In this embodiment, a range including the plain paper A and the bond paper B which is equal to or larger than a basis weight of 70 g/m² and smaller than a basis weight of 130 g/m² is determined as a basis weight range 1. A range including the plain paper C and the gloss paper D which is equal to or larger than the basis weight of 130 g/m² and smaller than a basis weight of 190 g/m² is determined as a basis weight range 2. A range including the bond paper E and the gloss paper F which is equal to or larger than the basis weight of 190 g/m² and smaller than a basis weight of 250 g/m² is determined as a basis weight range 3.

Subsequently, determination threshold values are set based on thicknesses of the sheets P for the individual basis weight ranges as denoted by solid lines. A determination threshold value of the basis weight range 1 is a thickness of 125 μm, a determination threshold value of the basis weight range 2 is a thickness of 160 μm, and a determination threshold value of the basis weight range 3 is a thickness of 230 μm. A recording material determination table of the relationship among a type of sheet P, a basis weight range, and a determination threshold value is illustrated in FIG. 7B. Although the determination threshold values are average values of the thicknesses of the two types of sheet P included in the individual basis weight ranges in this embodiment, optimized values may be set in accordance with the number of types of sheet P to be determined or variation of detection values caused by non-uniformity of the basis weights and non-uniformity of the thicknesses in planes of the sheets P. In a case where a basis weight of the sheet P obtained as a result of the detection performed by the basis weight detection unit 31 is included in the basis weight range 1, it is determined that the sheet P is the plain paper A when a thickness thereof is smaller than 125 μm and the bond paper B when a thickness thereof is equal to or larger than 125 μm. Similarly, a type of sheet P is determined using the determination threshold values in the basis weight ranges 2 and 3.

Alternatively, the controller 10 may obtain density of the sheet P in accordance with Expression 1 using the basis weight and the thickness without using the recording material determination table of FIG. 7B and determine a type of sheet P based on the density. Furthermore, the controller 10 may set image forming conditions based on the density of the sheet P. For example, a sheet of low density has a larger number of air spaces when compared with a sheet of high density, and therefore, heat is difficult to be transmitted by the number of the air spaces. Therefore, larger heat quantity is required to fix an image on a sheet of low density when compared with a sheet of high density. Accordingly, in a case where an image is to be fixed on a sheet of low density, the controller 10 may change the image forming conditions such that a higher fixing temperature is set or a lower speed for conveying the sheet is employed when compared with a case where an image is fixed on a sheet of high density.

### Operation Sequence

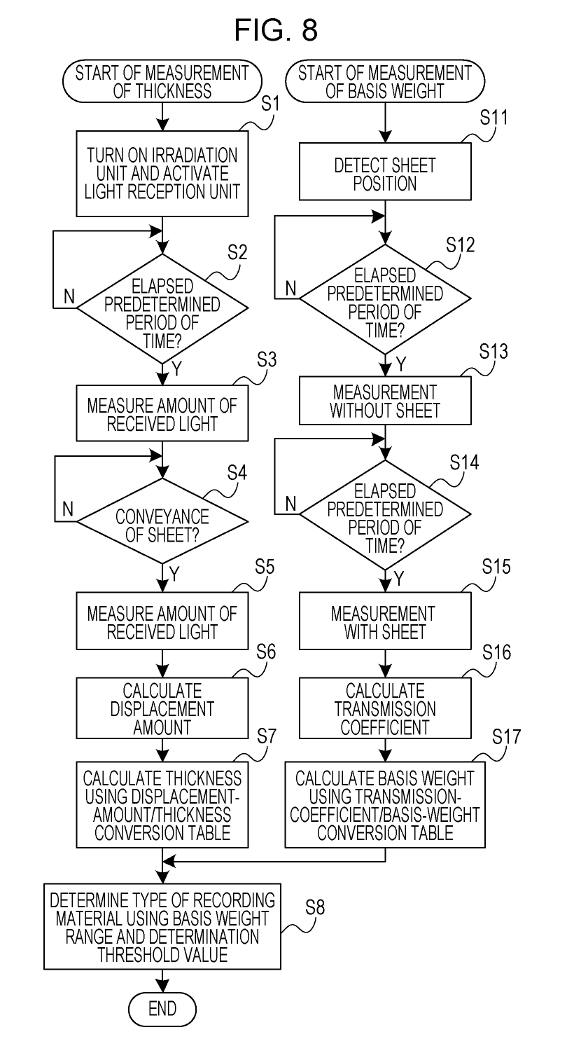

FIG. 8 is a flowchart of an operation sequence according to this embodiment. Control of the flowchart of FIG. 8 is executed by the controller 10 or the like based on a program stored in a read only memory (ROM) not illustrated.

First, an operation sequence of the thickness detection performed on the sheet P will be described. When printing is started, the thickness detection controller 338 turns on the irradiation unit 332 and activates the light reception unit 333 (S1). After the thickness detection controller 338 counts a predetermined period of time (S2), the light reception unit 333 receives light reflected by the sheet P which is in a stationary state and which is set in the sheet feeding cassette 2 and measures a light reception amount (S3). The thickness detection controller 338 obtains a distance between the surface of the sheet P and a light reception plane of the light reception unit 333 at this timing. Thereafter, the controller 10 supplies the single sheet P positioned on an uppermost surface of the sheet feeding cassette 2 using the sheet feeding roller 4 at a predetermined timing. The registration sensor 3 detects the sheet P and the controller 10 counts a period of time required for separation of a trailing end of the sheet P from the sheet feeding cassette 2 (S4). Thereafter, the thickness detection controller 338 performs control so that the light reception amount is measured again (S5). At this timing, the thickness detection controller 338 obtains a distance between a surface of the next sheet P and the light reception plane of the light reception unit 333. The thickness detection controller 338 calculates an amount of displacement between the sheet P before the sheet supply and the sheet P after the sheet supply in accordance with a difference between the obtained two distances (S6). The thickness detection controller 338 calculates a thickness of the sheet P with reference to a thickness conversion table representing the correlation between the displacement amount and the thickness of the sheet P (S7).

Second, an operation sequence of the basis weight detection performed on the sheet P will be described. When the printing is started, the controller 10 causes the registration sensor 3 to detect a conveyance position of the sheet P (S11). When a predetermined period of time has elapsed after the conveyance position is detected (S12), the basis weight detection controller 320 performs measurement without a sheet (S13). When the sheet P has reached the basis weight detection unit 31 after the predetermined period of time has elapsed (S14), the basis weight detection controller 320 performs measurement with a sheet (S15). The basis weight detection controller 320 calculates a transmission coefficient using a result of the measurement without a sheet and a result of the measurement with a sheet (S16). The basis weight detection controller 320 calculates a basis weight of the sheet P with reference to a basis weight conversion table representing the correlation between the transmission coefficient and the basis weight of the sheet P (S17). The controller 10 determines a type of sheet P in accordance with a determination threshold value in a basis weight range with reference to the determination threshold value conversion table indicating the relationship between the basis weight range of the detected sheet P and the determination threshold value (S8). Then the controller 10 sets image forming conditions corresponding to the detected type of sheet P. The control of this flowchart is thus terminated.

As described above, according to this embodiment, the type of sheet P which may not be determined only based on the basis weight may be determined using the basis weight of the sheet P and the thickness of the sheet P. Specifically, an image forming apparatus capable of determining the type of sheet P with high accuracy and forming a high-quality image may be provided.

### Second Embodiment

In a second embodiment, an image forming apparatus including a recording material determination apparatus which determines a type of recording material using information on a surface property of the recording material in addition to information on a basis weight of the recording material and information on a thickness of the recording material will be described. Descriptions in main portions are the same as those of the first embodiment, and only portions different from the first embodiment will now be described.

### Schematic Configuration of Image Forming Apparatus

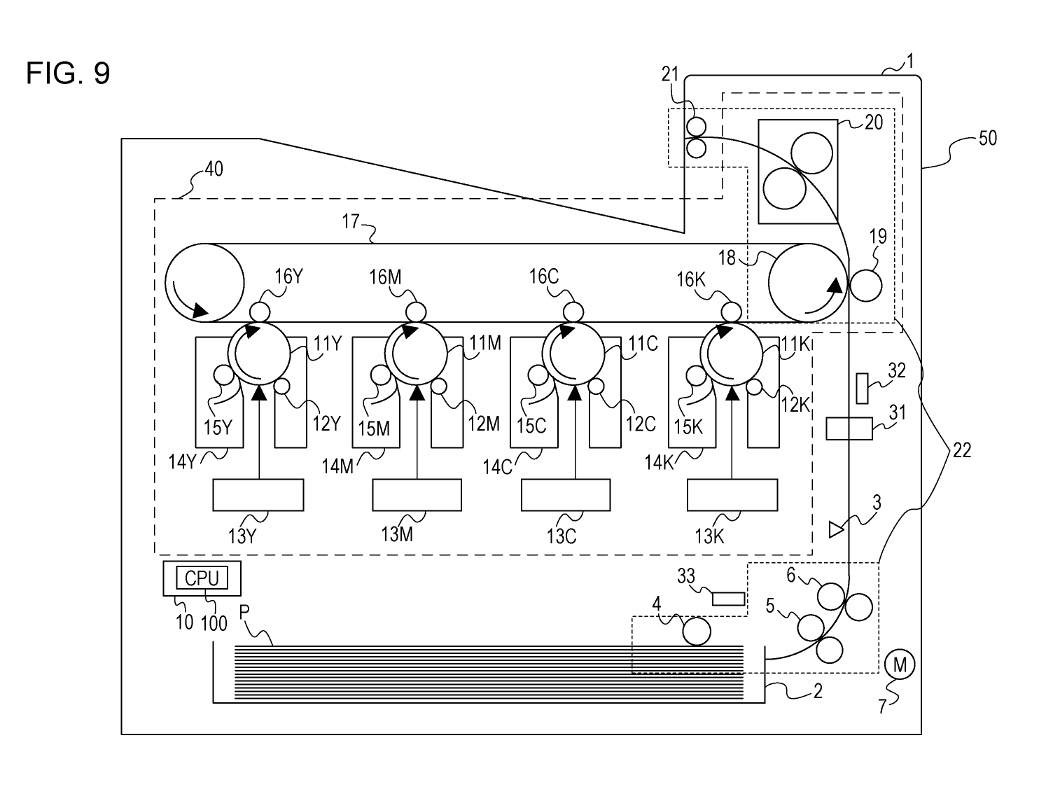

FIG. 9 is a diagram schematically illustrating a configuration of the image forming apparatus according to the second embodiment of the present disclosure. The second embodiment is different from the first embodiment in that a surface property detection unit 32 is provided.

The recording medium determination apparatus of this embodiment includes the surface property detection unit 32 which detects information on a surface property of a sheet P in addition to a basis weight detection unit 31 and a thickness detection unit 33. The surface property detection unit 32 is disposed on a conveyance guide and detects the sheet P which is supplied from a sheet feeding cassette 2.

### Surface Property Detection Unit 32

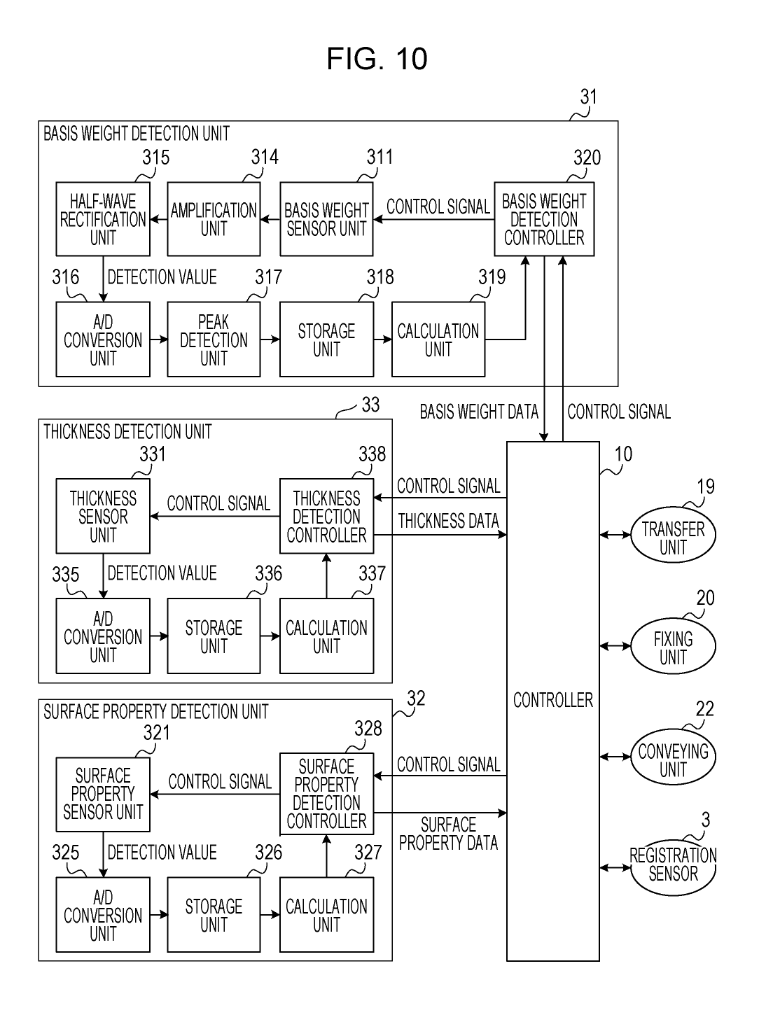

Operation of the surface property detection unit 32 according to this embodiment will be briefly described. FIG. 10 is a block diagram schematically illustrating operation of the surface property detection unit 32. The surface property detection unit 32 includes a surface property sensor unit 321, an A/D conversion unit 325, a storage unit 326, a calculation unit 327, and a surface property detection controller 328. The outline of the operations of the basis weight detection unit 31 and the thickness detection unit 33 is the same as that of the first embodiment, and therefore, a description thereof is omitted.

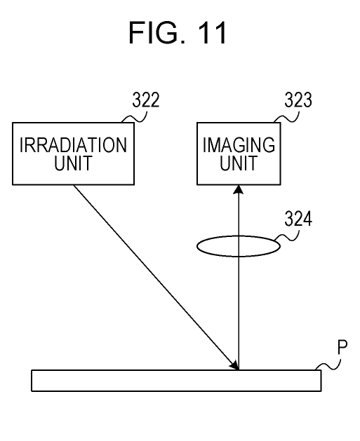

An example of a configuration of the surface property sensor unit 321 is illustrated in FIG. 11. The surface property sensor unit 321 includes an irradiation unit 322, an imaging unit 323, and an imaging lens 324. The irradiation unit 322 is a white LED, and the imaging unit 323 is a CMOS line sensor. In the surface property sensor unit 321, the irradiation unit 322 irradiates the sheet P with light. A surface image on the sheet P is captured by forming an image on the imaging lens 324 using the light reflected by the sheet P and receiving the light by the imaging unit 323. Here, contrast of shade of light generated by roughness of a surface of the sheet P is enhanced by irradiating the sheet P with light at a certain angle.

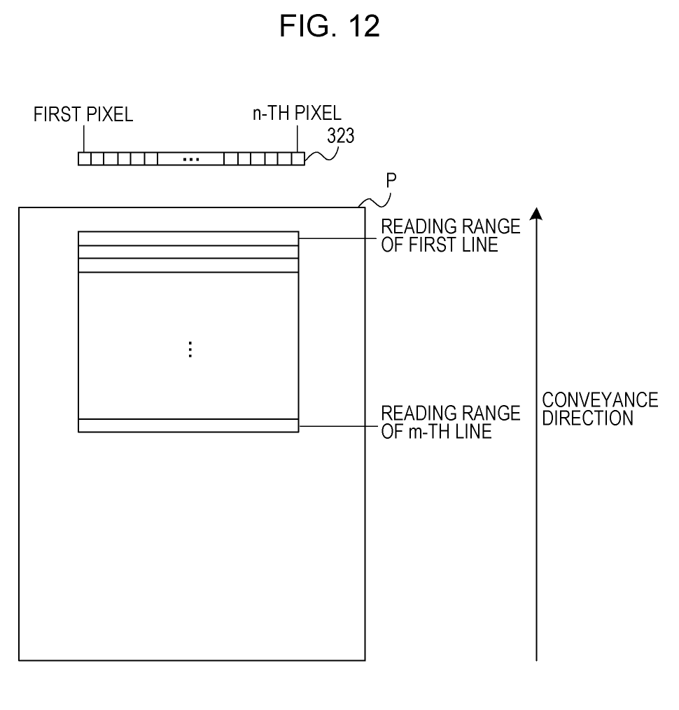

An operation of reading the surface image will be described with reference to FIG. 12. In this embodiment, moving-sheet-reading detection is performed while the sheet P is conveyed using the CMOS line sensor which is the imaging unit 323. In the CMOS line sensor, a number of light receiving elements corresponding to n arbitrary pixels are arranged in parallel to a conveyance surface of the sheet P and arranged along a direction orthogonal to a conveyance direction of the sheet P (a width direction). The light receiving elements receive, through the imaging lens 324, light reflected by the sheet P which is being conveyed. The CMOS line sensor which has received the light outputs signals corresponding to light reception amounts obtained by photoelectric conversion for individual pixels. A region corresponding to a number of reading lines is imaged by repeatedly performing the series of operations a number of times corresponding to m lines which is arbitrary set.

Although the white LED is used as the irradiation unit 322 in this embodiment, any device may be employed as long as the device is capable of emitting light of a wavelength receivable by the imaging unit 323, and a monochromatic LED of visible light or near infrared light or a halogen lamp may be used, for example. Similarly, in the imaging unit 323, light receiving elements, such as CCD sensors, may be used for the detection instead of CMOS sensors.

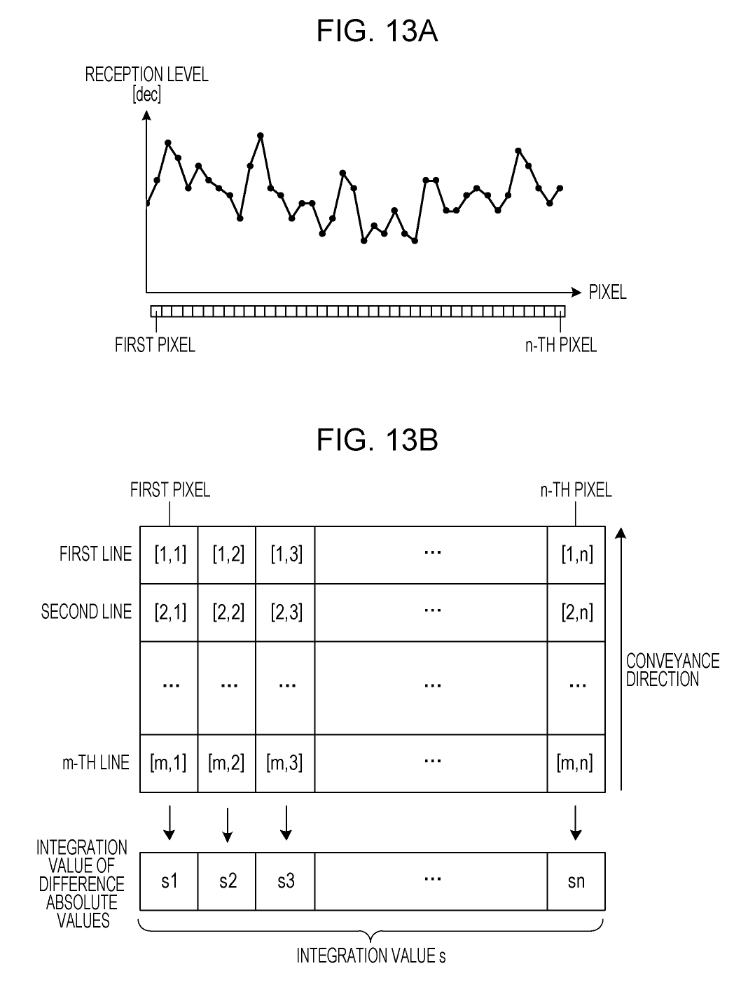

The A/D conversion unit 325 converts an analog value obtained from the imaging unit 323 into a digital value to be output. The storage unit 326 stores the digital output value obtained from the A/D conversion unit 325. The calculation unit 327 performs a calculation process using the obtained digital output value so as to extract a feature value of a surface property. The calculation of the feature value of the surface property will be described with reference to FIGS. 13A and 13B.

FIG. 13A is a graph illustrating reception levels of the light receiving elements of the CMOS line sensor in a certain line. An axis of abscissae denotes pixels corresponding to the light receiving elements of the CMOS line sensor and an axis of ordinates denotes a reception level [dec]. The reception level is obtained by cancelling photosensitivity non-uniformity by performing shading correction. Assuming that data of an n-th pixel in an m-th line is denoted by [m, n], pixel data may be represented as illustrated in FIG. 13B.

First, an absolute value of a difference between data [1, 1] of a first pixel in a first line and data [2, 1] of a first pixel in a second line is calculated. Second, one line is shifted, and an absolute value of a difference between data [2, 1] of the first pixel in the second line and data [3, 1] of a first pixel in a third line is calculated. This operation is repeatedly performed until data [m−1, 1] of a first pixel in an (m−1)-th line and data [m, 1] of a first pixel in an m-th line are reached. A value obtained by integrating difference absolute values for m lines is stored as an integration value s1 of the difference absolute values of the first pixels. This calculation is performed until an n-th pixel is reached. Then a value s obtained by integrating integration values of the difference absolute values of the n pixels is determined as a feature value of a surface property.

The feature value of the surface property is determined in accordance with the contrast of shade obtained when light is emitted to the sheet P. The feature value of the surface property is increased as the sheet P has a rougher surface, and the feature value of the surface property is reduced as the sheet P has a smoother surface. Although the feature value of the surface property is calculated by the method described above in this embodiment, the calculation method is not limited to this.

The surface property detection controller 328 performs operation control of the surface property sensor unit 321. The surface property detection controller 328 controls a start timing and an end timing of the surface property detection operation and driving of the irradiation unit 322 and the imaging unit 323. Furthermore, the surface property detection controller 328 transmits surface property data of the sheet P obtained from the storage unit 326 to the controller 10.

The controller 10 controls operations of a transfer portion 19, a fixing portion 20, and a conveying unit 22 in accordance with a result of the detection of the surface property of the sheet P.

### Variation of Detection Value

Different detection values of surface properties are obtained in different sheets P even if the sheets P are the same brand similarly to different detection values of basis weights and different detection values of thicknesses. The variation of the detection values of the surface properties also occurs owing to a difference of fiber directions of the sheets P in addition to a difference of production lots and a sensor which detects a surface property. Therefore, the determination is required to be made taking a variation range of the detection value of the surface property into consideration, and if a variation range of a certain sheet P overlaps with that of a sheet P of another brand, the determination may not be made with high accuracy.

### Principle of Sheet Type Detection

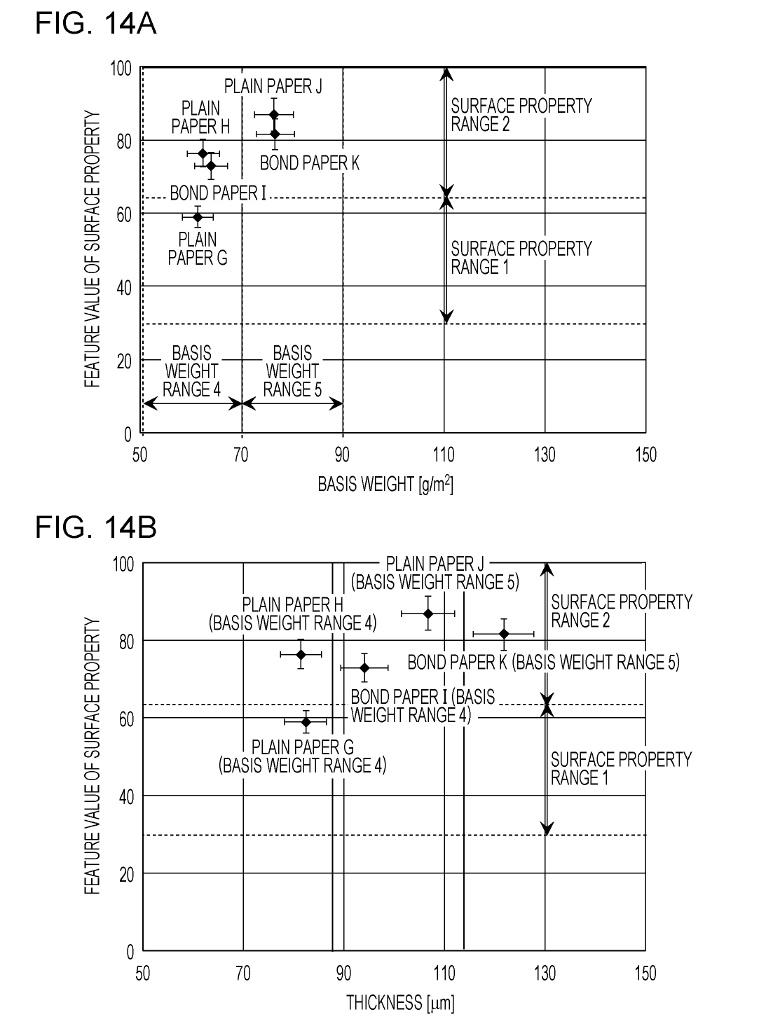

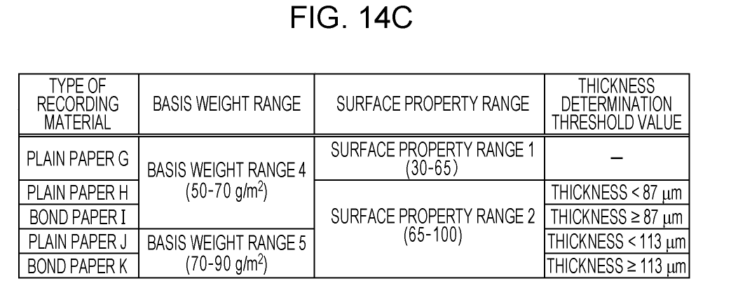

Principle of the recording material determination using the basis weight detection unit 31, the thickness detection unit 33, and the surface property detection unit 32 will be described. FIGS. 14A to 14C are examples of results of the basis weight detection, the thickness detection, and the surface property detection in a case of four different types of sheet P (plain paper G, plain paper H, bond paper I, plain paper J, and bond paper K). It is assumed here that detection values of a basis weight, detection values of a thickness, and detection values of a surface property of the individual types of sheet P vary by ±5% relative to the detection values and are indicated by error bars.

FIG. 14A is a graph illustrating the relationship between a result of detection of a basis weight and a result of detection of a surface property. An axis of abscissae denotes a basis weight [g/m²] of the sheet P, and an axis of ordinates denotes a feature value of a surface property of the sheet P. As for the feature value of the surface property, the surface property is rougher as the value is increased and is smoother as the value is reduced. As illustrated in FIG. 14A, the plain paper G, the plain paper H, and the bond paper I are included in a basis weight range 4, and the plain paper J and the bond paper K are included in a basis weight range 5. Furthermore, the plain paper G is included in a surface property range 1, and the plain paper H, the bond paper I, the plain paper J, and the bond paper K are included in a surface property range 2. Accordingly, although the plain paper G may be identified, discrimination between the plain paper H and the bond paper I and discrimination between the plain paper J and the bond paper K are difficult since variation ranges of detection values of the basis weight overlap with each other and variation ranges of detection values of the surface property overlap with each other. Therefore, a type of sheet P may not be determined with high accuracy only using the detection values.

To address this problem, a detection value of a thickness is used for the determination. The relationship between a result of the detection of the thickness and a result of the detection of the surface property is illustrated in FIG. 14B. An axis of abscissae denotes a thickness [um] of the sheet P, and an axis of ordinates denotes a feature value of the surface property of the sheet P. When the sheets P are compared with each other using the detection values of the thickness, the detection values of the plain paper H and the bond paper I do not overlap with each other or the detection values of the plain paper J and the bond paper K do not overlap with each other even in the variation ranges, and therefore, the determination may be made using a determination threshold value of the thickness. A recording material determination table representing the relationship between a type of sheet P and a detection value is illustrated in FIG. 14C. In this way, even in a case where the determination may not be made only using the basis weight of the sheet P and the feature value of the surface property of the sheet P, the sheet P may be determined using the detection value of the thickness.

Furthermore, density of the sheet P may be obtained without using the recording material determination table of FIG. 14C but using Expression 1 executed by the controller 10. Then a determination table for obtaining a type of sheet P using density and a surface property may be separately provided so that a type of sheet P is determined with reference to the table.

### Operation Sequence

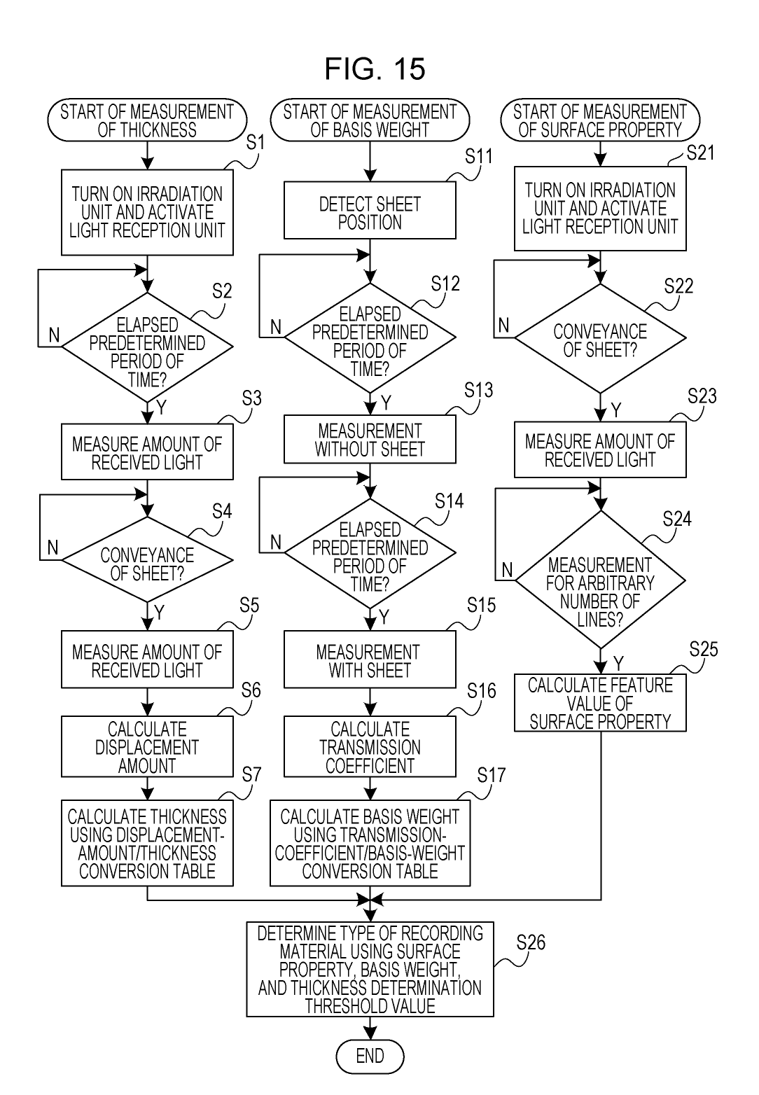

FIG. 15 is a flowchart of an operation sequence according to this embodiment. Control of the flowchart of FIG. 15 is executed by the controller 10 or the like based on a program stored in a ROM not illustrated.

Here, the operation sequence of the basis weight detection and the operation sequence of the thickness detection which are described above are omitted, and only an operation sequence of the surface property detection performed on the sheet P will be described. When printing is started, the surface property detection controller 328 turns on the irradiation unit 322 of the surface property sensor unit 321 and activates the imaging unit 323 (S21). When conveyance of the sheet P is started and a registration sensor 3 detects a current position of the sheet P, the controller 10 counts a predetermined period of time. After the predetermined period of time has elapsed, at a timing when the sheet P has reached the surface property detection unit 32 (S22), the surface property detection controller 328 performs control such that measurement of a light reception amount of light reflected by the sheet P is performed (S23). After the measurement of the light reception amount is performed for an arbitrary number of lines (S24), the surface property detection controller 328 calculates a feature value of a surface property using read detection values (S25). The controller 10 determines a type of sheet P using a basis weight detection value, a thickness detection value, a surface property detection value, and determination threshold values (S26). Then the controller 10 sets image forming conditions corresponding to the detected type. The control of this flowchart is thus terminated.

As described above, according to this embodiment, the type of sheet P which may not be determined only based on a basis weight and a surface property may be determined using the basis weight of the sheet P, the surface property of the sheet P, and the thickness of the sheet P. Specifically, an image forming apparatus capable of determining the type of sheet P with high accuracy and forming a high-quality image may be provided.

Furthermore, although the detection unit including the basis weight detection unit 31, the thickness detection unit 33, and the surface property detection unit 32 is fixed on the printer 1 according to the first and second embodiments, the basis weight detection unit 31, the thickness detection unit 33, and the surface property detection unit 32 may be collectively detachable from the printer 1. If the detection unit is configured to be detachable, the user may easily exchange the detection unit when the detection unit is broken, for example. Alternatively, the detection unit may be additionally attachable to the printer 1.

Furthermore, the detection unit and the controller 10 may be integrated to be a recording material determination apparatus which is detachable from the printer 1 in the first and second embodiments. In this way, if the detection unit and the controller 10 are integrally exchangeable, the user may change the detection unit to a sensor having an additional function when functions of the detection unit is to be updated or added. Alternatively, the detection unit and the controller 10 may be simply integrated and additionally attachable to the printer 1.

Although the example of the laser beam printer is illustrated in the first and second embodiments, the image forming apparatus of the present disclosure is not limited to this, and the image forming apparatus may be a printer employing another printing method, such as an inkjet printer, or a copier.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-032599 filed Feb. 26, 2018, which is hereby incorporated by reference herein in its entirety.

What is claimed is:

1. An image forming apparatus comprising:
a transmission unit configured to transmit ultrasonic waves;
a reception unit configured to receive the ultrasonic waves transmitted from the transmission unit through a recording material;
an image forming unit configured to form an image on the recording material;
an irradiation unit configured to emit light;
a light reception unit configured to receive the light emitted from the irradiation unit and reflected by the recording material; and
a controller configured to control image forming conditions of the image forming unit based on an amplitude value of the ultrasonic waves received by the reception unit and a position in the light reception unit where the light reflected by the recording material is received.

2. The image forming apparatus according to claim 1, wherein the controller determines a basis weight of the recording material based on the amplitude value of the ultrasonic waves received by the reception unit and determines a thickness of the recording material based on the position in the light reception unit where the light reflected by the recording material is received.

3. The image forming apparatus according to claim 2, wherein the controller determines density of the recording material based on the basis weight of the recording material and the thickness of the recording material and controls the image forming conditions based on the determined density of the recording material.

4. The image forming apparatus according to claim 1, further comprising:
a tray on which the recording material is stacked; and
a conveyance guide configured to guide the recording material supplied from the tray to the image forming unit,
wherein the transmission unit transmits ultrasonic waves to the recording material which is being conveyed along the conveyance guide and the irradiation unit irradiates the recording material stacked on the tray with light.

5. The image forming apparatus according to claim 4, wherein the controller obtains a first distance between a surface of a first recording material and a light reception plane of the light reception unit based on a position in the light reception unit where the light reflected by the first recording material is received, obtains a second distance between a surface of a second recording material and the light reception plane of the light reception unit based on a position in the light reception unit where the light reflected by the second recording material which is to be supplied after the first recording material is received, and determines a thickness of the first recording material based on a difference between the obtained first distance and second distance.

6. The image forming apparatus according to claim 1, further comprising:
a second irradiation unit configured to emit light; and
an imaging unit configured to capture an image of the light which is emitted by the second irradiation unit and reflected by the recording material as an image of the recording material,
wherein the controller controls the image forming conditions based on the amplitude value of the ultrasonic waves received by the reception unit, the position in the light reception unit where the light reflected by the recording material is received, and the image of the recording material captured by the imaging unit.

7. The image forming apparatus according to claim 6, wherein the controller determines a surface property of the recording material based on the image of the recording material captured by the imaging unit.

8. The image forming apparatus according to claim 6, wherein the imaging unit includes a plurality of light receiving elements which are line sensors arranged in parallel to a conveyance plane of the recording material and arranged orthogonal to a conveyance direction of the recording material.

9. The image forming apparatus according to claim 1, wherein the image forming conditions include a speed for conveying the recording material, a value of a voltage to be applied to a transfer unit included in the image forming unit, and a temperature used when a fixing unit included in the image forming unit fixes an image on the recording material.

10. An image forming apparatus comprising:
a basis weight detection unit configured to detect information on a basis weight of a recording material;
a thickness detection unit configured to detect information on a thickness of the recording material;
an image forming unit configured to form an image on the recording material; and
a controller configured to determine density of the recording material based on the information on the basis weight detected by the basis weight detection unit and the information on the thickness detected by the thickness detection unit and control image forming conditions of the image forming unit.

11. The image forming apparatus according to claim 10, wherein the image forming conditions include a speed for conveying the recording material, a value of a voltage to be applied to a transfer unit included in the image forming unit, and a temperature used when a fixing unit included in the image forming unit fixes an image on the recording material.

12. A recording material determination apparatus comprising:
a transmission unit configured to transmit ultrasonic waves;
a reception unit configured to receive the ultrasonic waves transmitted from the transmission unit through a recording material;
an irradiation unit configured to emit light;
a light reception unit configured to receive the light emitted from the irradiation unit and reflected by the recording material; and
a determination unit configured to determine a type of recording material based on an amplitude value of the ultrasonic waves received by the reception unit and a position in the light reception unit where the light reflected by the recording material is received.

13. The recording material determination apparatus according to claim 12, wherein the determination unit determines a basis weight of the recording material based on the amplitude value of the ultrasonic waves received by the reception unit and determines a thickness of the recording material based on the position in the light reception unit where the light reflected by the recording material is received.

14. The recording material determination apparatus according to claim 13, wherein the determination unit determines density of the recording material based on the basis weight of the recording material and the thickness of the recording material and determines a type of recording material based on the determined density of the recording material.

15. The recording material determination apparatus according to claim 12, further comprising:
a second irradiation unit configured to emit light; and
an imaging unit configured to capture an image of the light which is emitted by the second irradiation unit and reflected by the recording material as an image of the recording material,
wherein the determination unit determines a type of recording material based on the amplitude value of the ultrasonic waves received by the reception unit, the position in the light reception unit where the light reflected by the recording material is received, and the image of the recording material captured by the imaging unit.

16. The recording material determination apparatus according to claim 15, wherein the determination unit determines a surface property of the recording material based on the image of the recording material captured by the imaging unit.

17. The recording material determination apparatus according to claim 15, wherein the imaging unit includes a plurality of light receiving elements which are line sensors arranged in parallel to a conveyance plane of the recording material and arranged orthogonal to a conveyance direction of the recording material.

18. A recording material determination apparatus comprising:
a basis weight detection unit configured to detect information on a basis weight of a recording material;
a thickness detection unit configured to detect information on a thickness of the recording material; and
a determination unit configured to determine density of the recording material based on the information on the basis weight detected by the basis weight detection unit and the information on the thickness detected by the thickness detection unit and determine a type of recording material based on the determined density.
